(19) United States
(12) Patent Application Publication
(10) Pub. No.: US 2007/0056119 A1
(43) Pub. Date: Mar. 15, 2007

(54) Method for treating hydrophilic stains in a lipophlic fluid system

(76) Inventors: Robb Richard Gardner, Cincinnati, OH (US); William Michael Scheper, Guilford, IN (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/580,154

(22) Filed: Oct. 12, 2006

Related U.S. Application Data
(63) Continuation-in-part of application No. 11/438,879, filed on May 23, 2006.
Application No. 11/438,879 is a division of application No. 10/876,181, filed on Jun. 24, 2004, now abandoned.
(60) Provisional application No. 60/483,346, filed on Jun. 27, 2003.
(60) Provisional application No. 60/726,405, filed on Oct. 13, 2005.

(51) Int. Cl. C11D 3/00

(52) U.S. Cl. 8/115.51

(57) ABSTRACT

A fabric article cleaning regimen, more particularly a fabric article cleaning regimen employing a hydrophilic, aqueous-based pretreating composition in combination with a lipophilic laundering system

### CROSS-REFERENCE TO RELATED APPLICATIONS

This application claims the benefit of U.S. Provisional Application Ser. No. 60/726,405, filed on Oct. 13, 2005; and this application is a continuation-in-part application of U.S. patent application Ser. No. 11/438,879, filed May 23, 2006, which is a Divisional application of U.S. patent application Ser. No. 10/876,181, filed on Jun. 24, 2004, (now abandoned) which claims the benefit of U.S. Provisional Application Ser. No. 60/483,346, filed on Jun. 27, 2003.

### FIELD OF THE INVENTION

The present invention relates to a fabric article cleaning regimen, more particularly a fabric article cleaning regimen employing a hydrophilic, aqueous-based pretreating composition in combination with a lipophilic laundering system.

### BACKGROUND OF THE INVENTION

Conventional in-home laundry cleaning is carried out with large amounts of water, typically in a washing machine at the consumer's home, or in a dedicated place such as a coin laundry. Although washing machines and laundry detergents have become quite sophisticated, the conventional water-based laundry process still fails to remove some soils from fabric articles. A wide variety of “pre-treatment” compositions and devices are available to the consumer to assist in soil removal. These compositions often require a subsequent aqueous wash to complete soil removal.

However, existing domestic pre-treatment systems or home dry cleaning kits can leave undesirable residues on clothing articles, even after an extended period of drying, and may visibly spread the soil over a larger area and/or creating rings around the original soil. Even with subsequent laundering (i.e., washing) treatment, these residues may still be visible.

Therefore, it is desirable to have a regimen for removing all types of soils, including hydrophilic and lipophilic soils, from fabric articles with minimal residue or fabric shrinkage or damage. It is also desirable that such regimen includes a pretreatment to preferentially remove at least one different type of soils (e.g., hydrophilic soils) when the subsequent laundering system preferentially removes another type of soils (e.g., lipophilic soils). It is further desirable to have fabric pretreatment that results in minimal fabric shrinkage or damage, and minimal dye or soil redeposition during subsequent laundering process.

### SUMMARY OF THE INVENTION

The present invention fulfills those desirable outcomes described above by providing a fabric article treatment regimen that comprises an aqueous foam pretreatment step to preferentially remove at least a first type of soils (typically hydrophilic soils, but hydrophobic soils may also beneficially removed) and a non-aqueous laundering step to preferentially remove a second type soils (typically lipophilic soils). Preferably, the non-aqueous laundering step is capable of reducing re-deposition of the first type of soils. The foam pretreatment provides slow and even action between the treating agents and the stains. The treating agents as well as the non-aqueous wash medium are gentle to the fabrics.

A garment stain removal kit containing the pretreating composition, the instructions of the treatment regimen, and optionally, the foam generating applicator, is provided.

The objects, features and advantages of the invention are further borne out in the following detailed description, examples and appended claims.

All percentages, ratios and proportions herein are on a weight basis based on an undiluted composition, unless otherwise indicated.

### DETAILED DESCRIPTION OF THE INVENTION

Definitions

“Fabric article” as used herein means any article that is customarily cleaned in a conventional laundry process or in a dry cleaning process. As such the term encompasses articles of clothing, linen, drapery, and clothing accessories. The term also encompasses other items made in whole or in part of fabric, such as tote bags, furniture covers, tarpaulins and the like.

“Stain” or “soil” as used herein means any undesirable substance on a fabric article that is the target of removal. Generally, stains are found only on a portion of the article and are generated by accidental contact between the soil and the fabric article. The term “hydrophilic stain” as used herein means that the stain is comprised of water at the time it first came in contact with the fabric article, or the stain retains a significant portion of water on the fabric article. Hydrophilic stain comprises one or more of the following exemplary hydrophilic soils: beverages, many food soils, water soluble dyes, bodily fluids such as sweat, urine or blood, outdoor soils such as grass stains and mud. The term “hydrophobic stains” means the stain comprises primarily of lipophilic soils, which have high solubility in or affinity for the lipophilic fluid. Examples of lipophilic soils include, but are not limited to body soils, such as mono-, di-, and tri-glycerides, saturated and unsaturated fatty acids, non-polar hydrocarbons, waxes and wax esters, lipids; and laundry materials such as nonionic surfactants; and mixtures thereof.

“Pretreated fabric article” as used herein means a fabric article that has been contacted with a pretreatment foam composition of the present invention prior to subsequent contact with a lipophilic fluid wash medium.

“Average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

Aqueous Foam Composition

The aqueous foam composition of the present invention comprises a hydrophilic stain removal agent, such as bleaches, enzymes, or soil repellents; a surfactant, such as silicone-containing surfactants; a foaming agent such as amine oxides, betaines or primary alkylamine surfactants; water and optionally an adjunct ingredient, such as perfumes, pH modifiers, soil release polymers or organic solvents.

In typical embodiments, the aqueous foam compositions comprise from about 0.0001% to about 20%, preferably from about 0.001% to about 10%, more preferably from about 0.5% to about 3% by weight of the composition of a hydrophilic stain removal agent; from about 0.01% to about 40%, preferably from about 0.01% to about 25%, more preferably from about 0.1% to about 10%, and more preferably from about 0.5% to about 2% by weight of the composition of a surfactant; from about 0.1% to about 25%, preferably from about 0.5 to about 10%, more preferably from about 1% to about 5% by weight of the composition of a foaming agent; and from about 50% to about 99%, preferably from about 70% to about 95%, more preferably from about 80% to about 90% by weight of composition of water; and optionally, from about 0.001% to about 10%, preferably from about 0.01% to about 5%, more preferably from about 0.1% to about 2% by weight of the composition of an adjunct.

In one embodiment, the aqueous foam composition comprises at least about 0.01 wt % bleach and/or at least about 0.001 wt % enzyme and/or at least about 0.01 wt % soil repellent; at least about 0.1 wt % silicone-containing surfactant; at least about 0.01 wt % amine oxide; and at least about 50 wt % water.

In another embodiments, the aqueous foam composition may be formulated to be effective in removing stains yet gentle to the fabric, for example, color-safe. For example, a color-safe bleach such as hydrogen peroxide may be included in the composition. In still another embodiment, the composition may be formulated to have a pH in the range of from about 6 to about 10, preferably from about 8 to about 10. A pH modifier may be used to control the pH of the composition. In yet another embodiment, the aqueous foam composition may be formulated to minimize the soil redeposition, especially in the laundering process. For example, a soil repellent may be included in the composition to provide such benefit.

The aqueous composition herein typically has a viscosity of less than about 5 Pa*s, preferably from about 0.05 Pa*s to about 5 Pa*s, more preferably from about 0.075 Pa*s to about 2 Pa*s, and even more preferably from about 0.1 Pa*s to about 0.4 Pa*s. The viscosity herein is measured on a Brookfield viscometer model #LVDVII+ at 20° C. The spindle used for these measurements is a S31 spindle with the appropriate speed to measure compositions of different viscosities

A. Hydrophilic Stain Removal Agent

Hydrophilic stain removal agents (which may also provide in certain formulations according to the present invention hydrophobic stain removal benefits) include, but are not limited to, bleaches, enzymes, soil repellents and soil release polymers. When present, the hydrophilic stain removal agent generally comprises from about 0.0001% to about 20%, preferably from about 0.01% to about 10%, more preferably from about 0.1% to about 5% by weight of the aqueous foam composition. It is recognized that amount of specific hydrophilic stain removal agent may vary from the above general ranges in certain embodiments. Exemplary hydrophilic stain removal agents are described below.

(i) Bleach

Bleach suitable for use herein contains one or more bleaching agents, preferably peroxygen bleaches, and more preferably hydrogen peroxide.

Suitable peroxygen bleaches to be used herein are selected from the group consisting of: hydrogen peroxide; organic or inorganic peracids; hydroperoxides; diacyl peroxides; and mixtures thereof.

Suitable activated peroxygen sources include, but are not limited to, preformed peracids, a hydrogen peroxide source in combination with a bleach activator, or a mixture thereof. Nonlimitng examples of preformed peracids include percarboxylic acids and salts; percarbonic acids and salts; perimidic acids and salts; peroxymonosulfuric acids and salts; persulphates such as monopersulfate; peroxyacids such as diperoxydodecandioic acid (DPDA); magnesium peroxyphthalic acid; perlauric acid; perbenzoic and alkylperbenzoic acids; and mixtures thereof. Another example is phthaloylamino peroxy caproic acid (PAP), as described in U.S. Pat. Nos. 5,487,818, 5,310,934, 5,246,620, 5,279,757 and 5,132,431. PAP is available from Ausimont Spa under the tradename Euroco®. Suitable sources of hydrogen peroxide include, but are not limited to, compounds selected from the group consisting of perborate compounds, percarbonate compounds, perphosphate compounds and mixtures thereof. Suitable types and levels of activated peroxygen sources are found in U.S. Pat. Nos. 5,576,282, 6,306,812 and 6,326,348.

Bleach activator is a compound that reacts with hydrogen peroxide to form a peracid. The peracid thus formed constitutes the activated bleach Suitable bleach activators include, but are not limited to, perhydrolyzable esters and perhydrolyzable imides such as, tetraacetyl ethylene diamine, octanoylcaprolactam, benzoyloxybenzenesulphonate, nonanoyloxybenzenesulphonate, benzoylvalerolactam, dodecanoyloxybenzenesulphonate.

Suitable bleach boosters include, but are not limited to, those described U.S. Pat. No. 5,817,614.

In one embodiment, the bleaching agents are color-safe bleaches such as peroxygen bleaches provided by a hydrogen peroxide source. The hydrogen peroxide source may comprise any compound that produces perhydroxyl ions on contact with water. Suitable water-soluble sources of hydrogen peroxide for use herein include percarbonates, perborates and persilicates and mixtures thereof.

In another embodiment, the bleaching agents are hydrogen peroxide aqueous solutions where in the hydrogen peroxide content ranges is at least about 1%, or at least about 5%, and less than about 50%, or less than about 25%. In a specific embodiment, a 30% hydrogen peroxide aqueous solution is used.

Other bleaching agents may also be used, including catalytic metal complexes such as those described in U.S. Pat. No. 5,576,282, U.S. Pat. No. 5,597,936, WO 00/332601, and U.S. Pat. No. 6,225,464; bleaching enzymes such as those described in US 2005/003988A1; photo bleaches such as those described in US 2004/0266648A1; and hypohalite bleaches.

When present, bleach comprises from about 0.01% to about 20%, preferably from about 0.1% to about 10%, more preferably from about 0.5% to about 3%, by weight of the aqueous foam composition.

(ii) Enzymes

Suitable enzymes for use herein include protease, amylase, lipase, cellulase, carbohydrase including mannanase and endoglucanase, and mixtures thereof. Enzymes can be used at their art-taught levels, for example, at levels recommended by suppliers such as Novozymes and Genencor. Typical levels in the compositions are from about 0.0001% to about 5%. When enzymes are present, they can be used at very low levels, e.g., from about 0.001% or lower, in certain embodiments of the invention.

(iii) Soil Repellents

The term “soil repellent” as used herein refers to materials that provide one or more of the following advantages: reducing the oleophilicity or hydrophilicity of fabric or fiber surface, inhibiting wicking of oily/hydrophobic or hydrophilic soils into the fabric or fiber bundles, and providing oil or water repellency during normal wear. Nonlimiting examples of soil repellents suitable for use herein include:

(a) an amphophilic polymer having at least one unit carrying a cationic functional group and its counterion and at least one unit having a hydrophobic character, the two are bonded together via an oligomeric or polymeric chain selected from the group consisting of polyvinyl alcohol, polyalkylene glycols, polysaccharides, acrylic polymers and copolymers thereof, such as those polymers described in U.S. Pat. No. 6,379,394;

(b) alkyl polysiloxanes, alkoxy polysiloxanes, alkylalkoxy polysiloxanes, fluorinated polysiloxanes, polyester modified polysiloxanes, amino goup-contianing polysiloxanes, such as those siloxane polymers described in U.S. Pat. No. 2,923,653; U.S. Pat. No. 2,962,290; U.S. Pat. No. 5,417,744; U.S. Pat. No. 5,759,685; U.S. Pat. No. 5,584,917; U.S. Pat. No. 6,074,470; and U.S. Pat. No. 6,676,733;

(c) fluorinated polyethers, organofluoro compounds having a fluorocarbon portion and a hydrocarbon portion, as well as alkyl, alkoxy, ester, urea, or isocyanate groups, such as those compounds described in U.S. Pat. No. 5,276,175; U.S. Pat. No. 5,509,939; U.S. Pat. No. 6,509,433; US 2005/0171279A1, and references therein.

When present, the soil repellent comprises from about 0.01% to about 20%, preferably from about 0.1% to about 10%, more preferably from about 0.5% to about 3%, by weight of the aqueous foam composition.

(iv) Soil Release Polymers

The term “soil-release” as used herein refers to the ability of the fabric article to be washed or otherwise treated to remove soils that have come into contact with the fabric article. The soil release polymers may not wholly prevent the attachment of soil to the fabric article, but may hinder such attachment and improve the cleaning of the fabric article. Nonlimiting examples of soil release polymers are described below.

Examples of fluorine-containing soil release polymers (fluoro-SRPs) useful in the present invention can be a polymer derived from perfluoroalkyl monomers, or from a mixture of perfluoroalkyl monomers and alkyl (meth)acrylate monomers. Exemplary fluoro-SRPs are commercially available under the tradename Repearl F35® in an aqueous suspension form from Mitsubishi, and under the tradenames Zonyl 7060®, Zonyl 8300®, and Zonyl 8787® from DuPont. Other suitable fluoro-SRPs are disclosed in U.S. Pat. No. 6,451,717; WO 01/98384; WO 01/81285; JP 10-182814; JP 2000-273067; WO 98/4160213, and WO 99/69126.

Exemplary silicone-containing soil release polymers (Si-SRPs) are commercially available as DF104®, DF1040®, SM2125®, SM2245®, SM2101®, SM2059® from GE, and Dow Coming 75SF® Emulsion.

Suitable Si-SRPs have a weight-average molecular weight in the range from about 1000 to about 10,000,000, or from about 5000 to about 5,000,000, or from about 10,000 to about 1,000,000. For example, when the Si-SRP is a curable aminosilicone, it tends to have a low molecular weight from about 1000 to about 100,000. The curable Si SRP is relatively flowable when applied to the fabrics and can be cured to form a film-like layer over the fabric surface. In other examples, Si-SRPs having molecular weight higher than 100,000 can be deposited onto fabric surface without further curing.

Also suitable for use as soil release polymer in the present invention are water soluble modified celluloses which include, but are not limited to: carboxymethylcellulose, hydroxypropylcellulose, methylcellulose, and like compounds. These compounds, and other suitable compounds, are described in Kirk Othmer Encyclopedia of Chemical Technology, 4^{th} Edition, vol. 5, pages 541-563, under the heading of “Cellulose Ethers”, and in the references cited therein.

Another class of suitable soil release polymers may comprise block copolymers of polyalkylene terephthalate and polyoxyethylene terephthalate, and block copolymers of polyalkylene terephthalate and polyethylene glycol. These compounds are disclosed in details in are discussed in U.S. Pat. No. 6,358,914 and U.S. Pat. No. 4,976,879.

Another class of soil release polymer is a crystallizable polyester comprising ethylene terephthalate monomers, oxyethylene terephthalate monomers, or mixtures thereof. Examples of this polymer are commercially available as Zelcon 4780® (from DuPont) and Milease T® (from ICI). A more complete disclosure of these soil release agents is contained in EP 0 185 427 A1.

When present, the soil release polymer comprises from about 0.01% to about 20%, preferably from about 0.1% to about 10%, more preferably from about 0.5% to about 3%, by weight of the aqueous foam composition.

B. Surfactants

Surfactants useful herein aid in the wetting of the fabric being pretreated and therefore may be selected from a wide variety of known surfactant materials as long as the surfactant used. is either completely removed by the subsequent non-aqueous laundering step, or if not removed (in whole or only in part) then the surfactant is not recognized after the laundering step by the consumer as a stain on the fabric that has been pretreated. Silicone-containing surfactants are preferred for use in the pretreatment compositions useful herein, alone or in combination with other surfactants.

Silicone-containing surfactants suitable for use herein contain at least one hydrophilic portion and at least one lipophilic portion. Suitable silicone-containing surfactants typically have the following general formulas:
Yᵤ-(Lₜ-Xᵥ)ₓ—Y′_{w} (I)
L_{y}-(Xᵥ—Yᵤ)ₓ-L′_{z} (II)

and mixtures thereof;

wherein L and L′ are solvent compatibilizing (or lipophilic) moieties, which are independently selected from:

(a) C1-C22 alkyl or C4-C12 alkoxy, linear or branched, cyclic or acyclic, saturated or unsaturated, substituted or unsubstituted;
(b) siloxanes having the formula:
   MₐD_{b}D′_{c}D″_{d}
wherein a is 0-2; b is 0-1000; c is 0-50; d is 0-50, provided that a+c+d is at least 1;

M is R¹₃₋ₑXₑSiO_{1/2} wherein R¹ is independently H, or an alkyl group, X is hydroxyl group, and e is 0 or 1;

D is R⁴₂SiO_{2/2} wherein R⁴ is independently H or an alkyl group;

D′ is R⁵₂SiO_{2/2} wherein R⁵ is independently H, an alkyl group or (CH₂)_{f}(C₆Q₄)_{g}O—(C₂H₄O)ₕ—(C₃H6O)ᵢ(CₖH₂ₖ)ⱼ—R³, provided that at least one R⁵ is (CH₂)_{f}(C₆Q₄)_{g}O—(C₂H₄O)ₕ—(C₃H₆O)ᵢ(CₖH₂ₖ)ⱼ—R³, wherein R³ is independently H, an alkyl group or an alkoxy group, f is 1-10, g is 0 or 1, h is 1-50, i is 0-50, j is 0-50, k is 4-8; C₆Q₄ is unsubstituted or substituted; Q is independently selected from H, C₁₋₁₀ alkyl, C₂₋₁₀ alkenyl, and mixtures thereof; and

D′ is R⁶₂SiO_{2/2} wherein R⁶ is independently H, an alkyl group or (CH₂)ₗ(C₆Q₄)ₘ(A)ₙ-[(T)ₒ-(A′)ₚ-]_{q}-(T′)ᵣZ(G)ₛ, wherein 1 is 1-10; m is 0 or 1; n is 0-5; o is 0-3; p is 0 or 1; q is 0-10; r is 0-3; s is 0-3; C₆Q₄ is unsubstituted or substituted; Q is independently selected from H, C₁₋₁₀ alkyl, C₂₋₁₀ alkenyl, and mixtures thereof; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; T and T′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl or alkenyl, a carbohydrate unsubstituted or substituted with a C₁₋₁₀ alkyl or alkenyl or an ammonium; G is an anion or cation such as H⁺, Na⁺, Li⁺, K⁺, NH₄⁺, Ca⁺², Mg⁺², Cl⁻, Br⁻, I⁻, mesylate or tosylate; and D″ can be capped with C₁-C₄ alkyl or hydroxy groups;

Y and Y′ are hydrophilic moieties, which are independently selected from hydroxy; polyhydroxy; C1-C3 alkoxy; mono- or di-alkanolamine; C1-C4 alkyl substituted alkanolamine; substituted heterocyclic containing O, S, N; sulfates; carboxylate; carbonate; and when Y and/or Y′ is ethoxy (EO) or propoxy (PO), it must be capped with R, which is selected from the group consisting of:
(i) a 4 to 8 membered, substituted or unsubstituted, heterocyclic ring containing from 1 to 3 hetero atoms; and

(ii) linear or branched, saturated or unsaturated, substituted or unsubstituted, cyclic or acyclic, aliphatic or aromatic hydrocarbon radicals having from about 1 to about 30 carbon atoms;

X is a bridging linkage selected from O; S; N; P; C1 to C22 alkyl, linear or branched, saturated or unsaturated, substituted or unsubstituted, cyclic or acyclic, aliphatic or aromatic, interrupted by O, S, N, P; glycidyl, ester, amido, amino, PO₄²⁻, HPO₄⁻, PO₃²⁻, HPO₃⁻, which are protonated or unprotonated;
u and w are integers independently selected from 0 to 20, provided that u+w≧1;
t is an integer from 1 to 10;
v is an integer from 0 to 10;
x is an integer from 1 to 20; and
y and z are integers independently selected from 1 to 10.

Nonlimiting examples of surfactants having the above formula include: alkanolamines/alkanolamides; phophate/phosphonate esters; gemini surfactants including, but are not limited to, gemini diols, gemini amide alkoxylates, gemini amino alkoxylates; capped nonionic surfactants; capped silicone surfactants such as nonionic silicone ethoxylates, silicone amine derivatives; alkyl alkoxylates; polyol surfactants; and mixtures thereof.

One class of silicone-containing surfactants are derived from poly(dimethylsiloxane). These silicone-containing surfactants include polyether siloxanes, typically with a weight average molecular weight from 500 to 20,000 daltons. Examples of silicone-containing surfactants described herein above may be found in EP 1,043,443A1, EP 1,041,189A1 and WO 01/34,706 (all assigned to GE Silicones); U.S. Pat. No. 5,676,705, U.S. Pat. No. 5,683,977, U.S. Pat. No. 5,683,473, and EP 1,092,803A1 (all assigned to Lever Brothers); and U.S. Pat. No. 6,890,892, US 2003/0060396A1, and US 2004/0266643A1 (assigned to Procter & Gamble).

Nonlimiting commercially available examples of suitable silicone-containing surfactants are TSF 4446® (ex. General Electric Silicones), XS69-B5476® (ex. General Electric Silicones); Jenamine® HSX (ex. DelCon) and Y12147® (ex. OSi Specialties).

Additional examples of silicone-containing surfactants suitable for use herein include, but are not limited to, the polyalkyleneoxide polysiloxanes having a dimethyl polysiloxane hydrophobic moiety and one or more hydrophilic polyalkylene side chains and have the general formula:
R¹—(CH₃)₂SiO—[(CH₃)₂SiO]ₐ—[(CH₃)(R¹)SiO]_{b}—Si(CH₃)₂—R¹
wherein a+b are from about 1 to about 50, preferably from about 3 to about 30 , more preferably from about 10 to about 25, and each R¹ is the same or different and is selected from the group consisting of methyl and a poly(ethyleneoxide/propyleneoxide) copolymer group having the general formula:
—(CH₂)ₙO(C₂H₄O)_{c}(C₃H₆O)_{d}R²
with at least one R¹ being a poly(ethyleneoxide/propyleneoxide) copolymer group, and wherein n is 3 or 4, preferably 3; total c (for all polyalkyleneoxy side groups) has a value of from 1 to about 100, preferably from about 6 to about 100; total d is from 0 to about 14, preferably from 0 to about 3; and more preferably d is 0; total c+d has a value of from about 5 to about 150, preferably from about 9 to about 100 and each R² is the same or different and is selected from the group consisting of hydrogen, an alkyl having 1 to 4 carbon atoms, and an acetyl group, preferably hydrogen and methyl group. Examples of these surfactants may be found in U.S. Pat. No. 5,705,562 and U.S. Pat. No. 5,707,613, both of which are assigned to Dow Corning Corporation.

Examples of this type of surfactants are the Silwet® surfactants which are available from CK Witco, OSi Division, Danbury, Connecticut. Preferred Silwet® surfactants are L-7600, L-7602, L-7604, L-7605, L-7657, and mixtures thereof.

Another suitable silicone surfactant is SF-1488®, which is available from GE silicone fluids.

A preferred silicone-containing surfactant is Dow Corning Q2-5211 (made by Dow Corning; CAS#: 67674-67-3) which is described as a 3-(polyoxyethylene)propyl heptamethyltrisiloxane compound.

C. Foaming Agent

Any material (including surfactants) that stabilizes the foam structure of the pretreatment composition is useful as a foaming agent. Surfactants may provide both the fabric wetting benefit described above for the surfactant component of the pretreatment composition and act as a foaming agent.

Non-limiting examples of foaming agents include: water-soluble amine oxides containing alkyl and hydroxyalkyl moieties; and betaines, including alkyl betaines, sulfo betaines and hydroxy betaines.

Suitable foaming agents also include amine surfactants such as primary alkylamines having from about 6 to about 22 carbon atoms; nonlimiting examples include oleylamine (commercially available from Akzo under the trade name ARMEEN OLD), dodecylamine (commercially available from Akzo under the trade name ARMEEN 12D), branched C₁₆-C₂₂ alkylamine (commercially available from Rohm & Haas under the trade name PRIMENE JM-T.

Optional Adjunct Ingredients

The aqueous foam compositions may optionally comprise at least one adjunct ingredient. The adjunct ingredients can vary widely and can be used at widely ranging levels. When a cleaning adjunct is used, it is used generally at a level of at least about 0.01%, preferably at least about 0.5%, more preferably at least about 1%, and typically less than about 20%, preferably less than about 10%, more preferably less than about 5%, by weight of the composition. However, some adjunct ingredients may be present in specific amounts different from the general amount above.

Perfumes and perfumery adjunct ingredients useful in the compositions of the present invention include a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes may comprise extremely complex mixtures of such ingredients. Pro-perfumes are also useful in the present invention. Such materials are those precursors or mixtures thereof capable of chemically reacting, e.g., by hydrolysis, to release a perfume, and are described in patents and/or published patent applications to Procter and Gamble, Firmenich, Givaudan and others.

Suitable solvents adjunct ingredients, in addition to water, include C1-C6 alcohols, C2-C6 diols, glycols, ethers, and mixtures thereof.

When solvent is used, it is used typically at a level of at least about 0.1%, preferably at least about 1%, more preferably at least about 2%, and typically less than about 30%, preferably less than about 20%, more preferably less than about 10%, by weight of the aqueous foam composition.

Nonlimiting examples of pH modifiers adjunct ingredients include the following buffering systems: D(+)-Tartaric acid and sodium hydroxide buffer, citric acid and sodium hydroxide, citric acid and sodium citrate, succinic acid and sodium hydroxide, Tris(hydroxymethyl)aminomethane (or Tris) and sodium hydroxide, potassium dihydrogen phosphate and sodium hydroxide.

Suitable odor control adjunct ingredients, which may optionally be used as finishing agents, include agents include, cyclodextrins, odor neutralizers, odor blockers and mixtures thereof. Suitable odor neutralizers include aldehydes, flavanoids, metallic salts, water-soluble polymers, zeolites, activated carbon and mixtures thereof.

Other cleaning adjunct ingredients suitable for use in the compositions of the present invention include, but are not limited to, builders including the insoluble types, such as zeolites including zeolites A, P and the so-called maximum aluminum P, and the soluble types such as the phosphates and polyphosphates, any of the hydrous, water-soluble or water-insoluble silicates, 2,2′-oxydisuccinates, tartrate succinates, glycolates, NTA and many other ethercarboxylates or citrates; chelants including EDTA, S,S′-EDDS, DTPA and phosphonates; inorganic thickeners such as clays, silicates; water soluble organic thickeners such as carboxylated vinyl polymers, incuding polyacrylics, polyacrylamides, ethoxylated cellulose, hydroxypropyl cellulose, hydroxyethyl cellulose, xanthum gums, guar gums, alginates; optical brighteners; processing aids such as crisping agents and/fillers; anti-redeposition agents; hydrotropes, such as sodium, or calcium cumene sulfonate, potassium napthalenesulfonate, or the like; thickeners; alkalinity sources or alkalis such as those based on sodium or potassium including the hydroxides, carbonates, bicarbonates and sulfates and the like; non-silicone surfactants, such as nonionic, anionic, cationic surfactants; dye transfer inhibiting agents, anti-microbial agents, enzyme stabilizers, antibacterial agents, fabric softening agents such as quaternary ammonium compounds (quats) or esterquats; and combinations of one or more of these adjunct ingredients.

Non-Aqueous Wash Medium

The non-aqueous wash medium useful herein comprises one or more lipophilic fluids. In one embodiment, the non-aqueous wash medium comprises more than 50%, preferably more than 80% by weight of the wash medium of linear and/or cyclic siloxanes, preferably cyclic siloxanes, and more preferably decamethyl cyclopentasiloxanes, (“D5”). In another embodiment, the non-aqueous wash medium comprises lipophilic fluids wherein cyclic siloxanes comprise more than 50%, preferably more than 80% by weight of the lipophilic fluid. In yet another embodiment, the non-aqueous wash medium comprises a predominant fluid which is a siloxane, preferably a cyclic siloxane.

As used herein, the term “predominant fluid” does not require the fluid to be present at more than 50 wt % of a fluid mixture. For example, in a mixture of siloxane and three fluids, A, B, and C, having the weight percent: silicone: 30%, B: 25%, C: 25%, D: 20%, siloxane is by the present definition the predominant fluid.

“Lipophilic fluid” as used herein means any liquid or mixture of liquid that is immiscible with water at up to 20% by weight of water. In general, a suitable lipophilic fluid can be fully liquid at ambient temperature and pressure, can be an easily melted solid, e.g., one that becomes liquid at temperatures in the range from about 0° C. to about 60° C., or can comprise a mixture of liquid and vapor phases at ambient temperatures and pressures, e.g., at 25° C. and 1 atm. pressure.

The suitable lipophilic fluid may be non-flammable or, have relatively high flash points and/or low VOC (volatile organic content) characteristics, these terms having conventional meanings as used in the dry cleaning industry, to equal to or exceed the characteristics of known conventional dry cleaning fluids.

Non-limiting examples of suitable lipophilic fluid materials include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

“Siloxane” as used herein means silicone fluids that are non-polar and insoluble in water or lower alcohols. Linear siloxanes (see for example U.S. Pat. No. 5,443,747, and 5,977,040) and cyclic siloxanes are useful herein, including the cyclic siloxanes selected from the group consisting of octamethyl-cyclotetrasiloxane (tetramer), dodecamethyl-cyclohexasiloxane (hexamer), decamethyl-cyclopentasiloxane (pentamer, commonly referred to as “D5”) and mixtures thereof. A suitable siloxane comprises more than about 50% cyclic siloxane pentamer, or more than about 75% cyclic siloxane pentamer, or at least about 90% of the cyclic siloxane pentamer. Also suitable for use herein are siloxanes that are a mixture of cyclic siloxanes having at least about 90% (or at least about 95%) pentamer and less than about 10% (or less than about 5%) tetramer and/or hexamer.

The lipophilic fluid can include any fraction of dry-cleaning solvents, especially newer types including fluorinated solvents, or perfluorinated amines. Some perfluorinated amines such as perfluorotributylamines, while unsuitable for use as lipophilic fluid, may be present as one of many possible adjuncts present in the lipophilic fluid-containing composition.

Other suitable lipophilic fluids include, but are not limited to, diol solvent systems e.g., higher diols such as C₆ or C₈ or higher diols, organosilicone solvents including both cyclic and acyclic types, and the like, and mixtures thereof.

Non-limiting examples of low volatility non-fluorinated organic solvents include for example OLEAN® and other polyol esters, or certain relatively nonvolatile biodegradable mid-chain branched petroleum fractions.

Non-limiting examples of glycol ethers include propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether.

Non-limiting examples of other silicone solvents, in addition to the siloxanes, are well known in the literature, see, for example, Kirk Othmer's Encyclopedia of Chemical Technology, and are available from a number of commercial sources, including GE Silicones, Toshiba Silicone, Bayer, and Dow Corning. For example, one suitable silicone solvent is SF-1528 available from GE Silicones.

Non-limiting examples of suitable glycerine derivative solvents include 2,3-bis(1,1-dimethylethoxy)-1-propanol; 2,3-dimethoxy-1-propanol; 3-methoxy-2-cyclopentoxy-1-propanol; 3-methoxy-1-cyclopentoxy-2-propanol; carbonic acid (2-hydroxy-1-methoxymethyl)ethyl ester methyl ester; glycerol carbonate and mixtures thereof.

Cleaning, detersive and/or fabric care agents may optionally be added to the non-aqueous wash medium. Nonlimiting examples of these agents are described in U.S. Pat. Nos. 6,660,703; 6,673,764; 6,734,153; 6,746,617; 6,828,295; 6,894,014; 2003/0119699A1; 2005/0000027A1; 2005/0000030A1; 2005/0003981A1.

Foam-Generating Applicator

The aqueous foam composition is preferably dispensed from a foam-generating applicator. The applicator comprises a vessel having a hollow body for containing the composition and a foam-generating dispenser which is operatively attached, directly or indirectly, to the vessel for generating a foam. The foam-generating dispenser may generate a foam via any method, such as a chemical reaction, an enzyme reaction and/or a mechanical action. A mechanical action typically involves imparting a gas, such as air, nitrogen, carbon dioxide, directly into the composition in a turbulent manner as it dispenses, so as to physically form a foam of the composition.

One embodiment of the foam-generating dispenser may include an air injection piston, a pump, an impinging surface, a mesh or net, and/or a sprayer. An exemplary foam-generating applicator is described in details in US 2004/0229763A1. Other nonlimiting examples of foam-generating applicators suitable for use herein include T8900, OpAd FO 8203 and 7512 series foamers from Afa-polytek, Holmond, The Netherlands; Ti, F2 and WR-F3 series foamers from Airspray International, Inc., North Pompano Beach, Fla. USA; TS-800 and Mixor series foramers from Saint-Gobain Calmar, Inc., City of Industry, Calif., USA; pump foamers and squeeze foamers from Daiwa Can Company, Tokyo, Japan; TS1 and TS2 series foamers from Guala Dispensing USA Inc., Hillsborough, N.J., USA; and YT-87L-FP, YT-87L-FX and YT-97 series foamers from Yoshino Kogyosho CO., Ltd., Tokyo, Japan.

When the aqueous composition is dispensed from the foam-generating applicator, an aqueous foam composition useful in the present invention is produced.

Foam to weight ratio is a measurement of the mL of foam generated per gram of composition. The foam-generating applicator useful herein generates a foam having a foam to weight ratio of greater than about 2 mL/g, preferably from about 3 mL/g to about 10 mL/g, more preferably from about 4 mL/g to about 8 mL/g.

Foam to weight ratio is measured as follows: a volumetric measuring device, such as a graduated cylinder is weighed to get a tare weight. Then, the composition is dispensed, using the foam-generating applicator, if appropriate, into a graduated cylinder a set number of strokes for non-continuous dispensing applicators or for a set time period for continuous dispensing applicators. Typically, ten strokes are applied to non-continuous applicators (pumps, sprayers) or ten seconds are used with continuous applicators. The dispensing rate in the test should be consistent with the dispensing rate during normal usage scenarios, for example, 120 strokes per minute for trigger sprayers, or 45 strokes per minute for palm pumps.

The volume of foam generated is measured in mL using the volumetric measuring device (graduated cylinder). The volumetric measuring device containing the dispensed composition is weighed in grams. The tare weight of the volumetric measuring device is subtracted from this weight. The result is the grams of the composition dispensed. Finally, the foam to weight ratio in mUg is calculated by dividing the volume of foam generated (in mL) by the weight composition dispensed (in g).

Methods

The aqueous foam composition may be applied to a stain, preferably a hydrophilic stain, on a fabric article in need of treatment by the foam-generating applicator. Once the composition is applied, it is allowed sufficient time for the composition, more specifically the stain removal agents, to penetrate the fabric and to become associate with the soils. The fabric article is then washed in a non-aqueous medium in a washing machine according to standard laundering practice.

The aqueous foam compositions are typically used for direct treatment of a soil or stained area of a textile or garment. Specifically, an effective amount of the aqueous foam composition is dispensed (manually or mechanically) from a dispensing device and applied directly to the location of a stain on a soiled garment or fabric article, optionally onto the surrounding area of the stain. The dispensing device can be the foam-generating applicator described above. To make the manual application process convenient and effective for the consumers, the applicator may be further equipped with a spraying mechanism such as a pump and a spray nozzle, a squeezable container, a liquid permeable applicator tip made of porous materials such as sponges or fibrous mats, a spinnable brush tip, and the like.

In use, an effective amount of the composition is dispensed as a foam and applied substantially evenly to a localized area on the fabric or garment. In typical embodiments, from about 0.1 to about 900 mg, preferably from about 50 to about 750 mg, more preferably from about 100 to about 400 mg composition per gram of treated fabric is applied. In a specific embodiment wherein the hydrophilic stain removal agent is about 3wt % of the composition, the effective amount of the stain removal agent applied to the fabric is from about 0.03 mg to about 30 mg per gram of treated fabric.

The foam composition is allowed to penetrate the fabric. Because the high air/gas content in the foamed composition, the soil removal agents in the composition penetrate the fabric more slowly and more evenly than if the composition were dispensed as sprayed or misted droplets. This allows the treating agents in the composition to have more time to associate with the stains before the fabric article is placed inside a laundering machine. The pretreatment time is at least about 10 seconds, preferably from about 10 to about 900 seconds, more preferably from about 20 to about 600 seconds, even more preferably from about 30 to about 300 seconds.

In addition to longer action time, it is surprising to find that the hydrophilic soils loosened from the fabric exhibit a lesser tendency to redeposit onto the aqueous pretreated spot during the subsequent non-aqueous wash step. Without being bound by theory, it is believed that when an aqueous pretreat composition is applied as droplets, water in the composition is instantaneously absorbed/wicked into the fabric, to form concentrated spots on the pretreated fabrics; such concentrated water spots act like magnets attracting the hydrophilic soils in a non-aqueous wash medium. In contrast, the foam composition allows for more even distribution of the treating agents as well as the carrier (i.e., water); thus, there are no concentrated water spots on the pretreated fabric to attract hydrophilic soils.

In another embodiment, one may manually apply agitation or abrasion to the fabric at the locus of the stain and optionally the surrounding area. Such manipulation provides the mechanical action helpful for physically breaking up the stains. This is particularly useful for aged stains that have been left untreated for an extended period of time such as days or weeks, and may have hardened.

In another embodiment, the entire process may take place inside a laundering apparatus, in a hands-free manner. Thus, the fabric articles are placed inside a fabric article treating apparatus; the fabric articles may initially be contacted by an aqueous foam composition and subsequently contacted by a non-aqueous wash medium comprising lipophilic fluid, preferably more than 50 wt % cyclic siloxane. The apparatus may be capable of executing automated dosing of the aqueous foam composition and/or the lipophilic fluid by the apparatus.

Products Containing Compositions and Instructions for use

The aqueous foam compositions of the present invention are preferably included in a product. The product preferably comprises an aqueous composition in a container, preferably a foam-generating applicator in accordance with the present invention, and further comprises instructions for using the product to launder fabrics by contacting a fabric in need of treatment with an effective amount of the composition, preferably to a localized area, and followed by a non-aqueous wash treatment, such that the soils are removed from the laundered article. It is recognized that the foam-generating applicator may be provided separately, and the aqueous composition may be transferred to the separately acquired foam-generating applicator prior to use or dispensing.

The present invention therefore also encompasses the inclusion of instructions on the use of the compositions of the present invention with packages containing the compositions herein or with other forms of advertising associated with the sale or use of the compositions. The instructions may be included in any manner typically used by consumer product manufacturing or supply companies. Examples include providing instructions: on a label attached to the container holding the composition; on a sheet either attached to the container or accompanying it when purchased; or in advertisements, demonstrations, and/or other written or oral instructions which may be associated with the purchase or use of the compositions.

Specifically the instructions may include a description of the use of the composition, for instance: the recommended amount of composition to apply to a localized (e.g., stained) area; the recommended amount of time to wait for the composition to penetrate the pretreated fabric; and the recommended wash medium to used in the subsequent laundering step.

In one embodiment, the product may be a garment stain removal kit comprising: (a) a dispenser comprising a vessel and a foam-generating dispensing device; (b) an aqueous composition comprising a hydrophilic stain removal agent and water, the hydrophilic stain removal agent is selected from the group consisting of a bleach, an enzyme, a soil repellent, a soil release polymer, and mixtures thereof; and (c) a set of instructions for using the kit comprising the steps of: (i) placing the composition in the vessel, if the composition and the vessel are provided separately; (ii) using the dispenser to apply an effective amount of the composition to at least a stained portion of a garment, wherein the composition is dispensed from the dispenser as a foam having a foam to weight ratio of greater than about 2 mL/g and the effective amount is at least about 0.1 mg/g of treated fabric; (iii) allowing the composition to penetrate the garment for at least about 10 seconds; and (iv) placing the garment in a laundry apparatus and contacting the garment with a non-aqueous wash medium comprising a predominant fluid of cyclic siloxanes.

Non-limiting examples of aqueous foam pretreatment compositions useful herein include the following:

| Ingredients | Function | Comp. 1 | Comp. 2 |
|---|---|---|---|
| Hydrogen peroxide | Bleach | 2% | 3% |
| Silicone surfactant | Fabric Wetting | 0.5% | 1% |
| (Dow Corning Q2-5211) | | | |
| Amine oxide | Foaming agent | 1% | 2% |
| Diethylene triamine | Chelant | 10 ppm | 25 ppm |
| pentaacetic acid (DTPA) | | | |
| Sodium hydroxide | pH adjustment | 600 ppm | 1000 ppm |
| Potassium chloride | pH adjustment | 400 ppm | 800 ppm |
| Citric acid | pH adjustment | 800 ppm | 1200 ppm |
| Water | Carrier solvent/stain | Balance | Balance |
| | solvation | | |

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modification that are within the scope of this invention.

What is claimed is:

1. A fabric treatment process comprising the steps of:
(a) contacting a stained portion of a substrate with an aqueous foam composition, thereby converting the substrate to a pre-treated substrate;
(b) contacting the pre-treated substrate with a non-aqueous wash medium comprising a predominant fluid comprising siloxane, thereby converting the pre-treated substrate to a treated substrate; and
(c) optionally, drying the treated substrate.

2. The process according to claim 1 wherein the aqueous foam composition comprises:
from about 0.0001% to about 20% by weight of the composition of a hydrophilic stain removal agent;
from about 0.01% to about 40% by weight of the composition of a surfactant; and
from about 50% to about 99% by weight of the composition of water.

3. The process according to claim 2 wherein the hydrophilic stain removal agent is selected from the group consisting of bleaches, enzymes, soil repellents, soil release polymers, and mixtures thereof.

4. The process according to claim 3 wherein the bleach is a peroxygen bleach selected from the group consisting of hydrogen peroxide, organic or inorganic peracids, hydroperoxides, diacyl peroxides, and mixtures thereof.

5. The process according to claim 3 wherein the enzyme is selected from the group consisting of protease, amylase, lipase, cellulase, carbohydrase, and mixtures thereof.

6. The process according to claim 2 wherein the aqueous foam composition further comprises from about 0.1% to about 25% by weight of the composition of a foaming agent.

7. The process according to claim 6 wherein the surfactant is a silicone-containing surfactant.

8. The process according to claim 2 wherein the aqueous foam composition further comprises from about 0.001 to about 10% by weight of the composition of an adjunct ingredient, wherein the adjunct ingredient is selected from the group consisting of perfumes, pro-perfumes, pH modifiers, solvents, non-silicone surfactants, builders, alkalinity sources, optical brighteners, hydrotropes, thickeners, process aids, odor control agents, odor neutralizers, dye transfer inhibiting agents, anti-microbial agents, enzyme stabilizers, antibacterial agents, fabric softening agents, and mixtures thereof.

9. The process according to claim 2 wherein the composition comprises:
from about 0.01% to about 10% by weight of the composition of a hydrogen peroxide bleach;
from about 0.1% to about 10% by weight of the composition of a silicone-containing surfactant;
from about 0.01% to about 10% by weight of the composition of a foaming agent comprising a member selected from the group consisting of amine oxides, betaines, primary alkylamine surfactants, or mixtures thereof; and
the balance of water.

10. The process according to claim 8 wherein the composition further comprises a pH modifier such that the composition has a pH of about 6 to about 10.

11. The process according to claim 1 wherein the siloxane is a cyclic siloxane selected from the group consisting of octamethylcyclotetrasiloxane, decamethylcyclopentasiloxane, and dodecamethylcyclohexasiloxane, and mixtures thereof.

12. The process according to claim 1 further comprising the step of providing a dispenser comprising a vessel for containing the aqueous foam composition and a foam-generating dispensing device in fluid communication with the composition.

13. The process according to claim 12 wherein, when the dispenser is employed with the composition, the dispenser generates a foam having a foam to weight ratio of greater than about 2 mL/g.

14. The process according to claim 1 wherein amount of the composition applied to the fabric articles is from about 0.1 to about 900 mg/g of treated fabric.

15. The process according to claim 1 wherein amount of hydrophilic stain removal agent applied to the fabric articles is from about 0.03 to about 30 mg/g of treated fabric.

16. A method for removing stains from fabric articles comprising the steps of:
a) contacting fabric articles with an aqueous foam composition; and
b) subsequently, contacting said fabric articles with a lipophilic fluid wash medium comprising at least about 50% by weight of the wash medium of siloxanes.

17. The method according to claim 16 wherein the aqueous foam composition comprises at least about 0.0001% by weight of the composition of a bleach, or an enzyme, or both; at least about 0.01% by weight of the composition of a silicone-containing surfactant; at least about 0.01% by weight of the composition of a foaming agent; and at least about 80% by weight of the composition of water.

18. The method according to claim 16 wherein the aqueous foam composition is dispensed from an applicator comprising a vessel and a foam-generating dispenser.

19. The method according to claim 16 wherein the amount of the aqueous foam composition applied to the fabric articles is from about 0.1 to about 900 mg/g of treated fabric.

20. A stain removal method for dry cleaning application comprising the steps of:
(a) applying an effective amount of an aqueous foam composition to at least a portion of a fabric article;
(b) allowing the composition to penetrate the fabric article for at least about 10 seconds;
(c) contacting the fabric article with a non-aqueous wash medium comprising a predominant fluid of cyclic siloxanes.

21. A substrate having been contacted by
(a) an aqueous foam composition comprising at least one bleach; and
(b) a lipophilic fluid comprising at least about 50 wt % cyclic siloxanes.

22. A substrate having been treated according to the method of claim 1.

23. A fabric article having been treated according to the method of claim 16.

24. A fabric article having been treated according to the method of claim 20.

25. A garment stain removal kit comprising:
(a) a dispenser comprising a vessel and a foam-generating dispensing device;
(b) an aqueous foam composition comprising a hydrophilic stain removal agent and water, wherein the hydrophilic stain removal agent is selected from the group consisting of a bleach, an enzyme, a soil repellent, a soil release polymer, and mixtures thereof; and
(c) a set of instructions for using the kit comprising the steps of:
(i) placing the composition in the vessel, if the composition and the vessel are provided separately;
(ii) using the dispenser to apply an effective amount of the composition to at least a stained portion of a garment, wherein the composition is dispensed from the dispenser as a foam having a foam to weight ratio of greater than about 2 mL/g and the effective amount is at least about 0.1 mg/g of treated fabric;
(iii) allowing the composition to penetrate the garment for at least about 10 seconds;
(iv) placing the garment in a laundry apparatus and contacting the garment with a non-aqueous wash medium comprising a predominant fluid of cyclic siloxanes.
